(19) United States
(12) Patent Application Publication
(10) Pub. No.: US 2004/0003259 A1
(43) Pub. Date: Jan. 1, 2004

(54) System and method for website login data management

(76) Inventor: Ezoe Chang, Hsin-Tien City (TW)

Correspondence Address: LAW OFFICES OF CLEMENT CHENG, 17220 NEWHOPE STREET #127, FOUNTAIN VALLEY, CA, 92708, US

(21) Appl. No.: 10/246,069

(22) Filed: Sep. 17, 2002

(30) Foreign Application Priority Data
Jun. 28, 2002 (TW) 091114461

(51) Int. Cl. H04L 9/00

(52) U.S. Cl. 713/182

(57) ABSTRACT

A system and method to login to different websites using a single account and password, The said method comprising: identifying a user based on the user's account and password; searching for a corresponding record file for website login, according to the user's account. Wherein the website login record files comprises at least the encrypted login data for the user to login to websites. Finally, decrypting the corresponding website login data that the user intends to login to and sending the decrypted login data to the assigned website for login.

### BACKGROUND OF THE INVENTION

1. Field of the Invention

The present invention relates to a system and method for website account management, especially to a system and method for managing and protecting website login data, besides allowing users to login on different Internet websites, one only needs a single account and password.

2. Description of the Prior Art

As the European Union unites the borders of European countries, you can travel around Europe with one ticket regardless of which country you are traveling in. On the other hand, Internet websites especially websites with shopping services or special information usually ask users the account and password to be identified before providing services and information.

Therefore, a user applying for a website membership, or service thereof, is normally asked for basic personal information to either receive or select an account and password to be used as identification to receive the customized service.

In fact, a user generally has several accounts and passwords for several websites, but the user generally uses the bookmark function provided in a browser to manage the address of those sites, but the function cannot manage or protect the accounts and passwords of those sites. Besides, the accounts and passwords are normally different, which proves inconvenient for the user to remember.

Furthermore, when a user intends to login to a website, he/she has to use a browser that links to a specific website login page then enter his/her account and password. If the data size of the login page is too large, the user must spend more time waiting for the page to be completely loaded to login, which means more bandwidth and user's time will be wasted. As a result, the drawbacks mentioned above are in need of improvement.

### SUMMARY OF THE INVENTION

According to the shortcomings mentioned in the background as coming from the management of accounts and passwords on the Internet. The present invention provides a system and method for managing and protecting website login data, besides allowing users to login to different websites on the Internet by using one single account and password.

Accordingly, the main object of the present invention is to manage the accounts and passwords for users to login websites.

Another object of the present invention is to protect the accounts and passwords for the user login websites.

A further object of the present invention is to save the bandwidth as the user logs in.

An additional object of the present invention is to enhance the speed of user login.

According to the foregoing objects, the present invention provides a method for recording website login data, comprising: receiving a login data entered by a user, wherein the login data includes at least an account, a password, a address of a login page of a website for identifying the login data; encrypting the identified login data; and storing the encrypted login data.

The foregoing step of identifying the login data entered by the user at least comprises the following steps. Searching the source code of the login page to find the variables of keeping login data and to identify the location of the login data. The next step is to send the login data to the identified location and receive a reply to confirm the correctness of the login data.

Further, the present invention provides a method to login to different websites with a single accessing account and accessing password. The steps of the method comprise the reception of an accessing account and accessing password to identify the user. Searching a corresponding website login record file according to the account. Wherein the website login record file includes at least one set of login data encrypted in advance for the user to login websites. Decrypting the encrypted login data for the website that the user intends to login; and then finally sending the decrypted login data to the website for login. As a result, the user only has to enter the accessing account and the accessing password once. After that the user just needs to select which website to login, rather than enter any account or password for respective sites.

As described above, the present invention enables the user to login to different websites rapidly without remembering accounts and passwords for respective sites. The features of the present invention is encrypting and storing the login data, furthermore, saving bandwidth, and enhancing the speed of login.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIGS. 1a to 1c shows the screenshots of a browser in a preferred embodiment of the present invention;

FIG. 2 is the flow chart to illustrate the operating steps of the preferred embodiment;

FIG. 3a is the flow chart to illustrate the procedure of identifying a new website login data;

FIG. 3b is the flow chart to illustrate the procedure of extracting needed data from a HTML document;

FIG. 4 is the flow chart to illustrate the procedure of login in the preferred embodiment; and

FIG. 5 illustrates the architecture of the system for managing website login data.

### DESCRIPTION OF THE PREFERRED EMBODIMENT

The preferred embodiment of the present invention is described and detailed as follows. In addition to the detailed description and demonstration, the present invention may be extensively practiced in other embodiments, and the scope of the present invention is not limited to the description and demonstration herein but within the scope of the claims hereafter.

The present invention provides a method for recording website login data, comprising: receiving login data entered by a user, wherein the login data includes at least an account, a password, a location of the login page of the website for identifying the login data entered by the user; encrypting the identified login data; and storing the encrypted login data.

The foregoing steps of identifying the login data entered by the user at least include the following steps. Searching for the source code of the login page to find out the variables of keeping the login data and to identify the locations for the identifying login data. Then to send the login data to the identified location; and receive a reply to confirm the correctness of the login data.

Further, the present invention provides a method to login to different websites with a single account and password. The steps of the method comprise the following. Receiving an account and password to identify the user. Searching the corresponding websites login records and files according to the account. Wherein the website login file records include at least one set of encrypted login data in advance, for the user to login websites. The encrypted login data for the website that the user intends to login is then decoded. Then, finally sending the decrypted login data to the website for login. As a result, the user only has to enter an account and password once. After that the user just needs to select which website to login, rather than enter any account or password for respective sites.

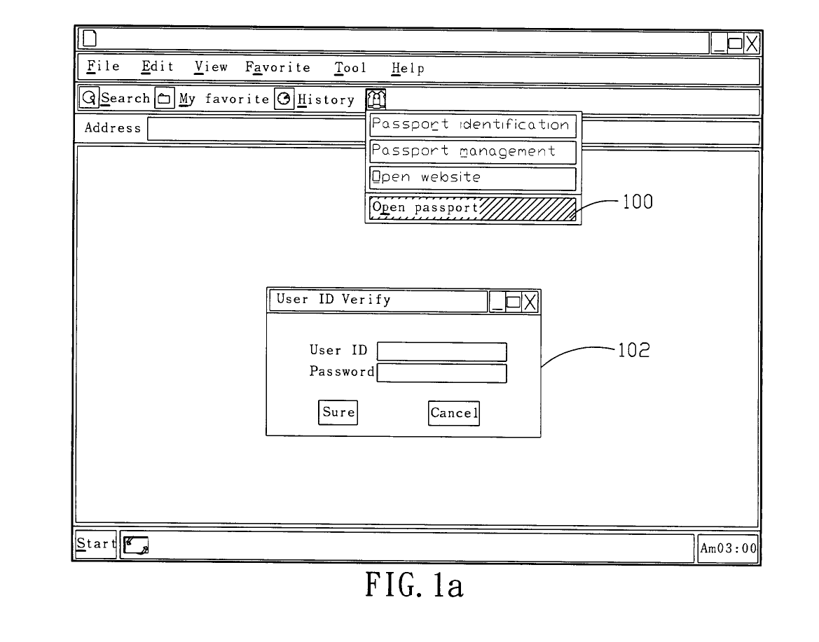

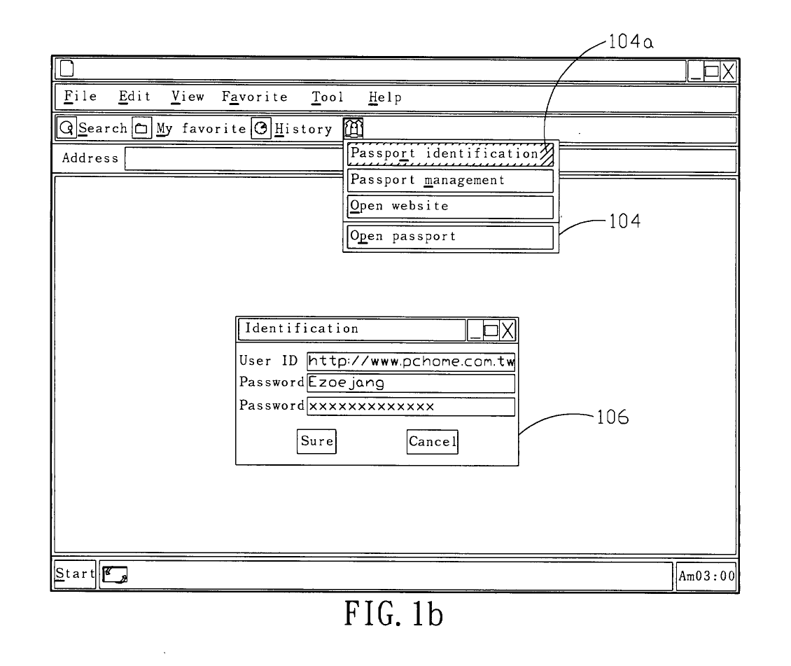

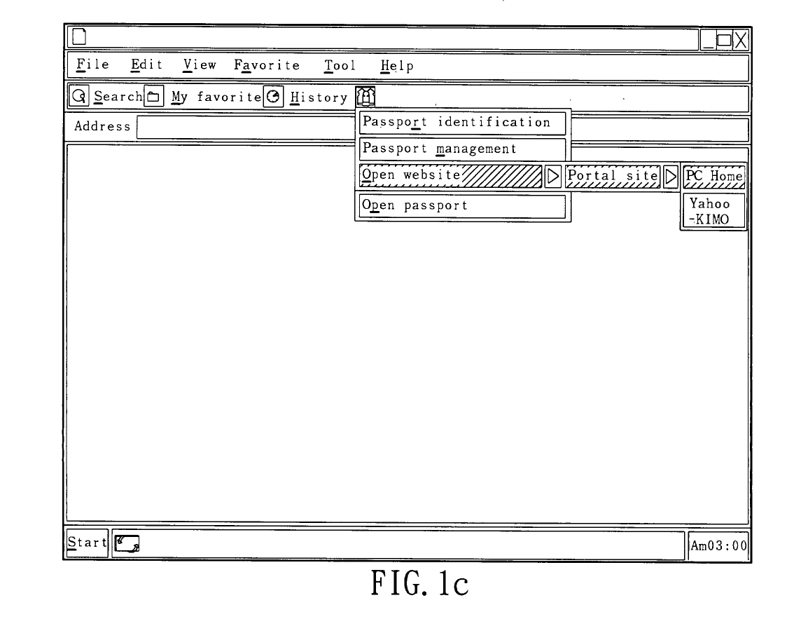

FIGS. 1a to 1c shows the screenshots of a browser that implements the preferred embodiment of the present invention, wherein a management object program is embedded into the browser to manage and protect the accounts and password information associated with website login. In other embodiments, the present invention is not limited to be embedded within a browser. As shown in FIG. 1a, a dialogue 102 will pop up to request a user entering the account and passwords after the user clicks on “open passport” 100. The user is not permitted to perform any function before entering the correct account and password. The function menu 104 as shown in FIG. 1b appears only after the correct account and password is entered. Wherein the account and password for “open passport” described above is the account and password for activating the management program, which means the user, needs a single account and password instead of remembering individual website login data.

As shown in FIG. 1b, an identifying window 106 for identifying login data is launched after the user clicks on the “passport identification” option 104a. For example, in this preferred embodiment, the user intends to add new login data of the website (http://www.pchome.com.tw), therefore, the user enters a account and password for login the site (http://www.pchome.com.tw) in the identifying window 106, and then the management program will performs the identifying task. If the account and password are correct, it will be saved and encrypted, accordingly, when the user intends to login the same site (http://www.pchome.com.tw), the user just selects the name of the identified website instead of entering the account and password again, as shown in FIG. 1c.

According to the foregoing description, the present invention improves the user login speed to different websites. The user doesn't have to remember the individual login data of sites. Furthermore, the present invention encrypts and saves the site login data in the user's computer for the purpose of protecting the user's private information.

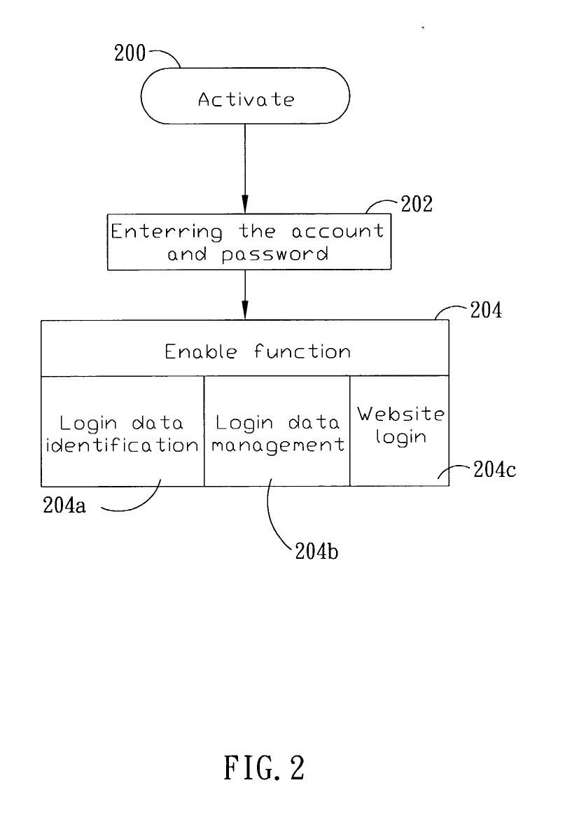

FIG. 2 is the flow chart to illustrate the operating steps of the preferred embodiment. The user activates the management program 200 and enters the account and password 202 needed to enable the function menu 204, where the functions are mainly the login data identification 204a, login data management 204b, and website login 204c. The login data identification 204a is used to identify a login data for a new site, the login data management 204b is used to manage said login data, and the website login function 204c is used to provide a list of those identified sites for user login instead of entering the individual login data.

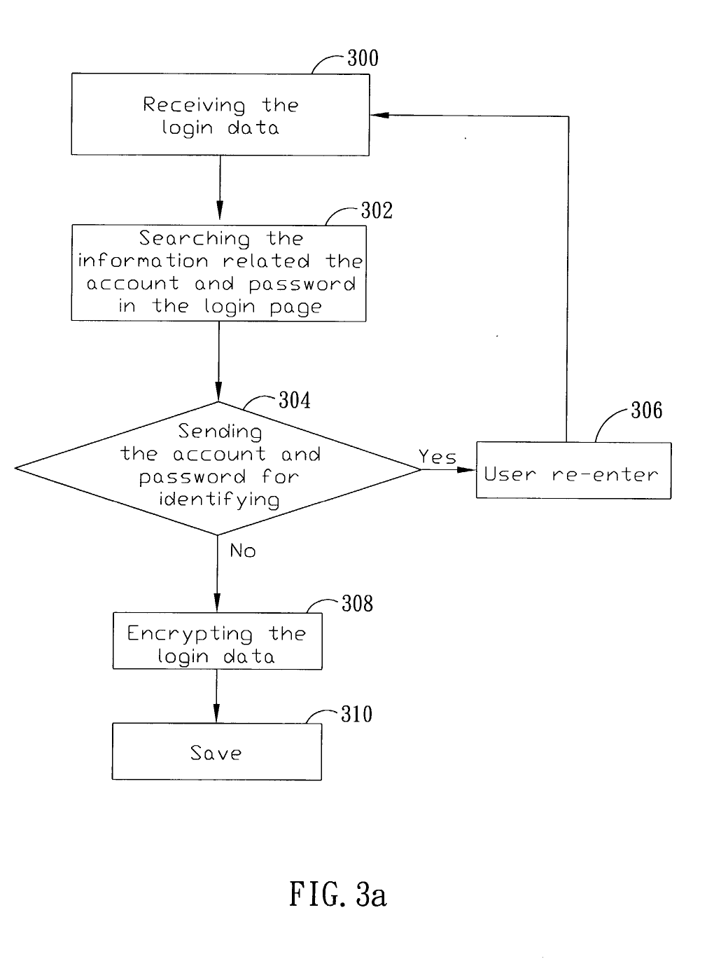

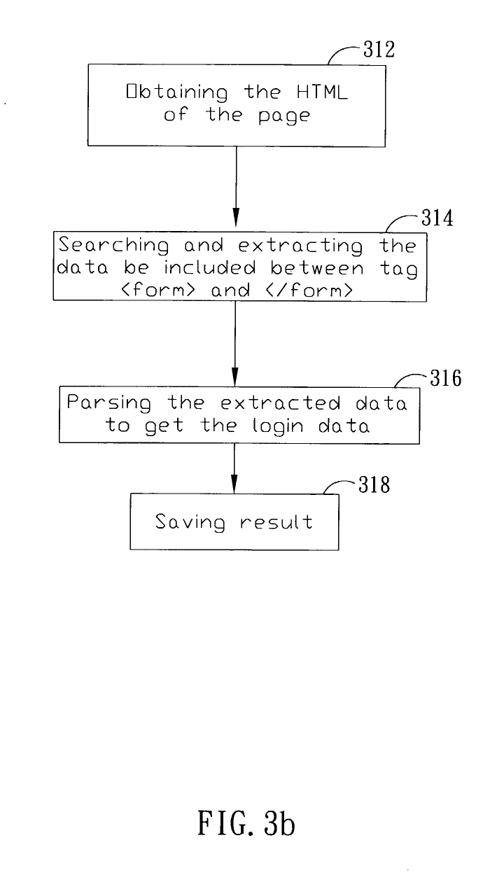

FIG. 3a is the flow chart to illustrate the procedure of identifying a new website login data. First, the website location and the login account and password are received 300, the login account and password are used to login to the website. Next, the login page of the website is obtained according to the website location, and then searching related accounts and passwords in the login page 302. The account and password is sent to the website to login 304, if the account and password is rejected, then the user re-enters the account and password 306 again. Finally the correct account and password are encrypted 308 and saved 310. In the preferred embodiment of the present invention, the encryption is by RSA (public/private golden key algorithm), but in other embodiments, the encryption is not limited to the use of RSA algorithm or any other encryption algorithm. The foregoing steps of searching related accounts and passwords in the login page 302 is described as follows. For example in this preferred embodiment, the login page of the website is http://www.pchome.com.tw, the portion of html (Hypertext Makeup Language code of the login page is listed as follows:

<form method=POST

action=http:/ /mail.pchome.com.tw/adm/flogin.php3>

<td bgcolor=“6FBA52” width=“124” class=“text”

align=“center”><img width=“1” height=“2”>

<a href=“http:/ /mail.pchome.com.tw/”

style=“color:white”>e-mail

</a>
</td>
<td valign=“top” width=“6”><img src=“/img/a.gif” width=“6”

height=“6” border=“0” alt=“”></td></tr></table>

<img width=“1” height=“3”><br>
<table width=“130” border=“0” cellspacing=“0” cellpadding=“6”

bgcolor=“BBD976”><tr><td align=“center”>

<table border=“0” cellspacing=“0” cellpadding=“0” width=“110”>
<tr><td class=“text3”><span style=“color:white”>account
</span></td><td><img width=“2” height=“3”></td>
<td><input type=“text” name=“fuid” size=“8”

maxlength=“20”></td></tr>

<tr><td class=“text3”><span style=“color:white”>password
</span></td><td><img width=“2” height=“3”></td>
<td><input type=“password” name=“fpass” size=“8”

maxlength=“20”></td></tr>

</table><img height=3 width=1><br>
<table width=“115” border=“0” cellspacing=“0”

cellpadding=“0”><tr><td >&nbsp;

<a href=“http:/ /isp.pchome.com.tw/register/”

style=“color:white ; font-size:9pt ; “>join as members</a>

</td><td align=“right”><input type=“submit” value=“login
”></td></tr></table>
</td></form>

The code used in the site to identify the account and password is found from <form action=“ . . . ” metho=“post”>, as for example in the preferred embodiment: http://mail.pchome.com.tw/adm/flogin.php3, and all strings marked with a <input> tag are found, as for example in the preferred embodiment:

<input type=“text” name=“fuid” size=“8” maxlength=“20”><input type=“password” name=“fpass” size=“8” maxlength=“20”>, wherein the <input type=‘text’ . . . > represents the user's account, the <input type=password . . . > represents the user's password, and <input type=hidden . . . > represents the hidden information.

As shown in the html portion, after the user enters the account and password, the website will save the login account in variable “fuid”, and the login password in variable “fpass”, and then sends the login data to http://mail.pchome.com.tw/adm/flogin.php3 to identify the user.

As a result, the searching step 302 shown in FIG. 3a is further divided into several blocks, as shown in FIG. 3b. First, obtaining the HTML code of the web page 312, and searching the data that's included between the tags <form> and </form> among the HTML code in step 314. Then, parsing the searched data to extract the data for login website in step 316, last saving the result in step 318, wherein the extracted data in step 316 includes the variables used to store login account and password, and the identifying location of the website for identifying the login data. As a result, the present invention enables the user to enter the login data of a specific website just once and pass the identification. When the next time the user intends to login to the same website, the present invention will automatically complete the login procedure instead of the user entering the login data again. The transfer protocol used in this preferred embodiment is HTTP (Hypertext Transfer Protocol), but it is not limited to employ this protocol. Besides, since the user can login without loading the login page of the website, the bandwidth will be saved.

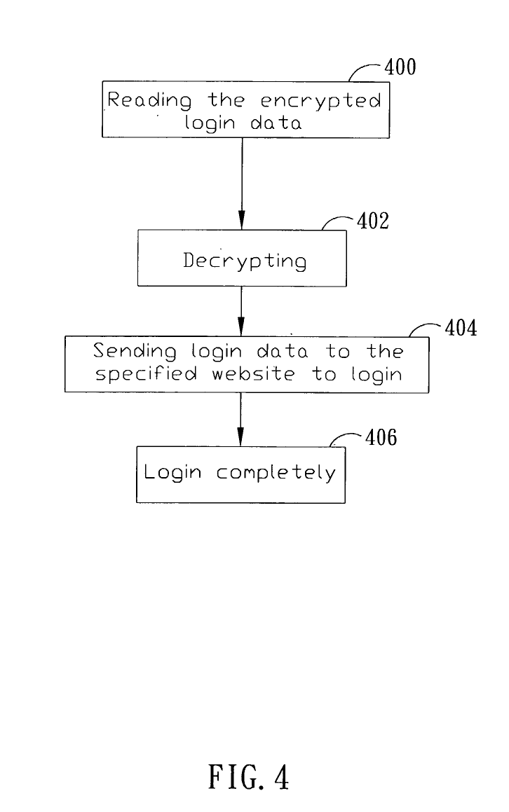

FIG. 4 is the flow chart to illustrate the login procedure in the preferred embodiment. When the user selects an identified website, the login data for the website is captured in step 400, wherein the login data at least includes a user's account and password for login to this website, a identifying location for identifying login data, and other necessary data. Next, the encrypted login data is decrypted in step 402, and the login data is sent to the identifying location to login in step 404, and finally, the login is completed in step 406.

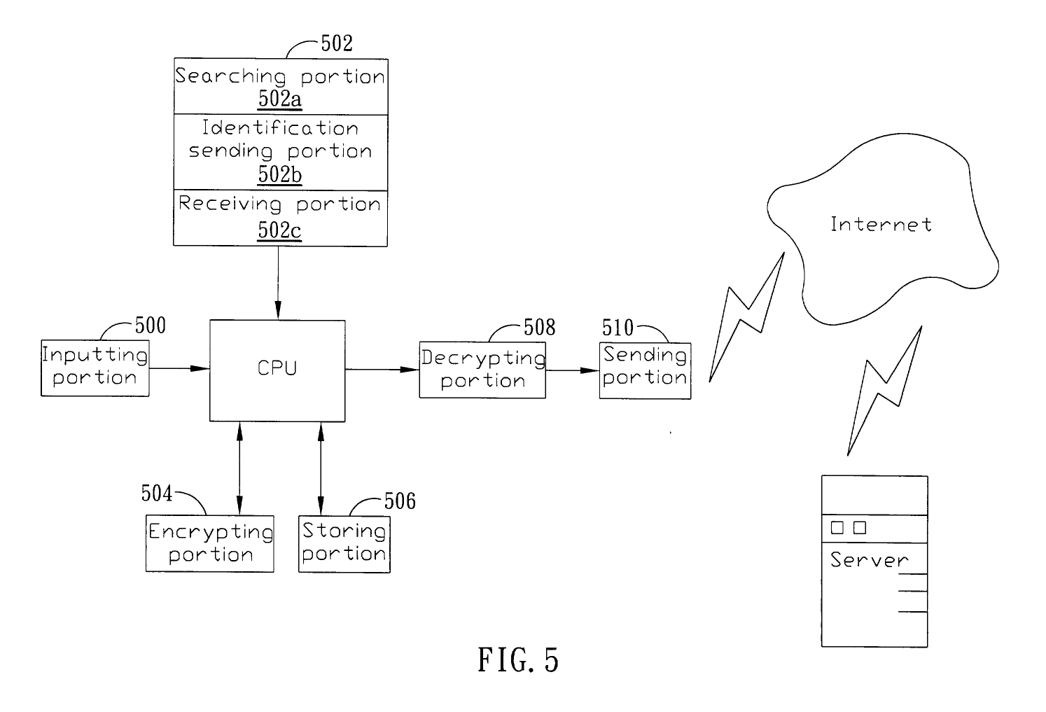

FIG. 5 illustrates the system architecture for managing website login data. The system at least comprises an input portion 500, an identifying portion 502, an encrypting portion 504, a storing portion 506, a decrypting portion 508, a sending portion 510 and a CPU. Wherein the input portion 500 receives a plurality of website login data that's entered by the user, the login data includes the login account and password for identifying the user and the corresponding website. The identifying portion 502 is divided into three portions: a searching portion 502a that searches for the variables in the HTML code of a login page used to store the login data, and identification location for identifying the login data. An identification sending portion 502b for sending the login data to the identification location; and a receiving portion 502c is used to receive a reply from the identified location to confirm the correctness of the login data.

Next, the login data that is identified by the identifying portion 502 is encrypted by the encrypting portion 504 and saved in the storage portion 506, wherein the storage portion 506 is a data storing medium, for example, can be a disk device or a flash memory, and so on.

When a user intends to login to a specific website, the corresponding login data saved in the storing portion 506 is decrypted by the decrypting portion 508 and sent by the sending portion 510 to a specific web server.

Accordingly, the present invention enables the user to login to different websites rapidly without remembering the accounts and passwords for respective sites. The features of the present invention are encrypting and keeping the login data, furthermore, saving bandwidth, and enhancing the login speed.

The information described above is only to demonstrate and illustrate the preferred embodiment of the present invention, and is not to limit the scope of the present invention; any equivalent variation and modification in light of the present invention is within the scope of the claims hereafter.

What is claimed is:

1. A management system for managing website login data, comprising:
an inputting portion for receiving a plurality of website login data entered by a user, wherein each of said login data includes a corresponding login account for logining a specified website;
a storing portion for saving said login data; and
a sending portion for sending said login data to said specified website selected by the user.

2. The management system according to claim 1, wherein said login data further includes an address of a login page and a password.

3. The management system according to claim 1, further comprising an identifying portion, said identifying portion is used to identify the correctness of said login data after said login data is sent.

4. The management system according to claim 3, wherein said identifying portion comprising:
a searching portion for searching variables and an identification location in the source code of said login page, wherein said variables are used to store said login data, and said identification location is used to identify said login data;
an identification sending portion for sending said login data to said identification location; and
an receiving portion for receiving a reply from said identification location to confirm the correctness of said login data.

5. The management system according to claim 1, further comprising an encrypting portion for encrypting said login data, and then saving said encrypted login data in said storing portion for protecting the privacy of said login data.

6. The management system according to claim 5, further comprising a decrypting portion for decrypting said encrypted login data before sending.

7. The management system according to claim 1, wherein said inputting portion receives an accessing code entered by said user, said accessing code is used to identify said user and activates said management system.

8. A method for website login management comprising:
receiving a plurality of website login data entered by a user, wherein each of said login data includes a corresponding login account for logining a specified website;
saving said login data; and
sending said login data to said specified website selected by the user.

9. The method for website login management according to claim 8, wherein said login data further includes an address of a login page and a password.

10. The method for website login management to claim 8, further comprising sending said login data, and identifying the correctness of said login data after said login data is sent.

11. The method for website login management according to claim 10, wherein said identifying step comprising:
searching variables and an identification location in the source code of said login page, wherein said variables are used to store said login data, and said identification location is used to identify said login data;
sending said login data to said identification location; and
receiving a reply from said identification location to confirm the correctness of said login data.

12. The method for website login management according to claim 8, further comprising encrypting said login data, and saving said encrypted login data for protecting the privacy of said login data.

13. The method for website login management according to claim 12, further comprising decrypting said encrypted login data before sending.

14. The method for website login management according to claim 8, further comprising receiving a accessing code entered by said user, said accessing code is used to identify said user and activates said management system.

15. A computer-readable storage medium, a management software is saved inside said storage medium, and said management software can be performed by said computer for managing website login data, said management software comprising:
an inputting module for receiving a plurality of website login data entered by a user, wherein each of said login data includes a login account for login a specified website;
a storing module for saving said login data; and
a sending module for sending said login data to said specified website selected by the user.

16. The computer-readable storage medium with said management software according to claim 15, wherein said login data includes an address of login page and a password.

17. The computer-readable storage medium with said management software according to claim 15, wherein said management software further comprising an identifying module for sending said login data, and identifying the correctness of said login data after said login is sent.

18. The computer-readable storage medium with said management software according to claim 17, wherein said identifying module comprising:
a searching module for searching variables and an identification location in the source code of said login page, wherein said variables are used to store said login data, and said identification location is used to identify said login data;
a identification sending module for sending said login data to said identification location; and
an receiving module for receiving a reply from said identification location to confirm the correctness of said login data.

19. The computer-readable storage medium with said management software according to claim 15, wherein said management software further comprising an encrypting module for encrypting said login data, and then saving said encrypted login data in said storing module for protecting the privacy of said login data.

20. The computer-readable storage medium with said management software according to claim 19, wherein said management software further comprising a decrypting module for decrypting said encrypted login data before sending.

21. The computer-readable storage medium with said management software according to claim 15, wherein said management software further comprising an identifying module for receiving a accessing code entered by said user, said accessing code is used to identify said user and activates said management software.
